(19) United States
(12) Patent Application Publication
(10) Pub. No.: US 2004/0027618 A1
(43) Pub. Date: Feb. 12, 2004

(54) Image defect detecting method

(75) Inventors: Hiroaki Nakamura, Kanagawa (JP); Kui Fu, Kanagawa (JP); Yoshifumi Donomae, Kanagawa (JP)

Correspondence Address: SUGHRUE MION, PLLC, 2100 Pennsylvania Avenue, NW, Washington, DC, 20037-3213, US

(73) Assignee: FUJI PHOTO FILM CO., LTD.

(21) Appl. No.: 10/452,905

(22) Filed: Jun. 3, 2003

(30) Foreign Application Priority Data
Jun. 3, 2002 (JP) 2002-161919

(51) Int. Cl. G06T 5/30; H04N 1/409; G06K 15/00

(52) U.S. Cl. 358/3.26; 382/275; 382/257

(57) ABSTRACT

The image defect detecting method detects, from image data obtained by reading photoelectrically an original, image defect candidates of an image to be reproduced by the image data which are due to damage of the original and foreign matter sticking to the original, or further foreign matter sticking to a reading system for reading the original, or foreign matter sticking to an image pick-up system for shooting a subject, and removes the image defect candidates in accordance with a density at which the image defect candidates are present, such that the image defect candidates present in a place where the density exceeds a predetermined state are removed and the image defect candidates which are not removed are regarded as image defects of the image to be reproduced by the image data.

### BACKGROUND OF THE INVENTION

1. Field of the Invention

The present invention relates in general to a technical field of digital image analysis. More particularly, the invention relates to an image defect detecting method in which image defects due to foreign matter such as dirt sticking to a film, flaws of a film, foreign matter such as dirt sticking to a reading system for reading a film, in particular to an image sensor such as a CCD, or foreign matter such as dirt sticking to an image pick-up system for shooting a subject, in particular to an image sensor such as a CCD can be accurately detected from an image which is obtained by photoelectrically reading an image or the like captured on a film or the like, or an image obtained by photoelectrically shooting a subject by a digital still camera (DSC).

2. Description of the Related Art

Currently, with regard to printing of an image captured on a photographic film such as a negative film or a reversal film (hereinafter, referred to as “a film” for short) onto a photosensitive material (photographic printing paper), so-called direct exposure in which an image on a film is projected and exposed to a photosensitive material is the mainstream.

On the other hand, in recent years, it is carried out that after an image recorded on a film is photoelectrically read and the read image is processed into digital signals, the digital signals are subjected to various image processing operations to obtain image data for recording, and a photosensitive material is exposed using recording light which is modulated in accordance with the image data to output the image data in the form of a print. The image data is also outputted as an image file to a recording medium such as a CD-R or an HD (hard disc).

In accordance with such digital processing operations, since an image captured on a film is read to obtain digital image data in order to execute image processing for the digital image data, not only color and density correction can be very suitably performed, but also the image processing operations such as gradation correction and sharpness processing (sharpness correction) which are basically impossible for the usual direct exposure type printers can be executed to obtain an image of high picture quality.

Now, as for a major factor causing degradation in picture quality when outputting an image of a film used as an original, there are image defects (hereinafter, referred to as “dust flaws”) due to foreign matter such as dust or dirt sticking to a film, and flaws of a film formed by friction or the like.

In a conventional direct exposure type printer, a film is cleaned and an image (film) is retouched with coloring materials through manual work by an operator, so that a print in which such dust flaws are corrected is outputted. On the other hand, in the digital processing in which an image on a film is photoelectrically read to be treated as the digital image data, the image data obtained through the reading operation is subjected to the image analysis, so that dust flaws can be detected, and also can be corrected through the image processing.

As a method of detecting such dust flaws of a film in a digital printer, heretofore, there has been known a method in which an image on a film is read with nonvisible rays such as infrared rays (IR rays) to analyze the resultant nonvisible rays image (refer to JP 06-28468 A and JP 11-75039 A).

That is to say, since the IR rays are not absorbed by an image (coloring matters) captured on a film, but are blocked/scattered by dust flaws, the dust flaws can be detected from a change in signal intensity when an image on a film is read with the IR rays.

However, while the dust flaw detecting method using IR rays is very excellent in detection accuracy, it is necessary to give an image reader (scanner) an image reading function provided by IR rays, which results in increase in costs of an image reader, and reduction in reading speed as well.

In addition, in a black-and-white film, a part of coloring matters and reduction silver forming an image may have an absorption component of the IR rays. Consequently, the dust flaw detection using IR rays can not be utilized in such a white-and-black film.

Under such circumstances, a method of detecting simply dust flaws using the image data (R, G, and B components) of R (red), G (green), and B (blue) has been desired, and also, various methods have been proposed.

As an example of a method of detecting dust flaws of an image by image analysis using the R, G, and B components, there is known a method in which two line segments meeting the conditions are detected on the basis of edge detection and a flaw is detected using the two line segments sandwiching the flaw therebetween (refer to JP 2000-74846 A), or a method in which a dust flaw candidate area is detected on the basis of the magnitude of a difference between a smoothing image and an original image, and a dust flaw is detected on the basis of the features of the candidate area such as a change in shape or color (refer to JP 2000-92319 A).

However, in an image, for example, as in a suit of clothes having a pattern formed thereon, a large number of areas each having a profile similar to a dust flaw are present in many cases.

For this reason, in the dust flaw detection based on the image analysis using those R, G, and B components, there is encountered a problem in that a large number of areas occur which are judged to be dust flaws of an image by mistake though the areas are not essentially dust flaws. Then, if correction for an image (dust flaw correction) is carried out according to the dust flaw detection based on the image analysis, conversely, the picture quality of the reproduced image may be degraded.

### SUMMARY OF THE INVENTION

In the light of the foregoing, the present invention has been made in order to solve the above-mentioned problems associated with the prior art, and it is, therefore, an object of the present invention to provide an image defect detecting method which is capable of detecting image defects due to foreign matter such as dust or dirt sticking to a film, flaws made on a film, foreign matter such as dust or dirt sticking to a reading system for reading a film, in particular to an image sensor such as a CCD, or foreign matter such as dust or dirt sticking to an image pick-up system for shooting a subject, in particular to an image sensor such as a CCD, with high accuracy without misdetection from an image obtained by photoelectrically reading an image or the like captured on a film or the like, or from an image obtained by photoelectrically shooting a subject by a digital still camera.

In order to attain the object described above, the present invention provides an image defect detecting method, comprising:

detecting, from image data obtained by reading photoelectrically an original, image defect candidates of an image to be reproduced by the image data which are due to damage of the original and foreign matter sticking to the original; and

removing the image defect candidates in accordance with a density at which the image defect candidates are present, such that the image defect candidates present in a place where the density exceeds a predetermined state are removed and the image defect candidates which are not removed are regarded as image defects of the image to be reproduced by the image data.

The removing of the image defect candidates present in the place where the density exceeds a predetermined state preferably comprises executing enlargement processing on the image defect candidates; then executing reduction processing on the thus enlarged image defect candidates; and at least one of removing the image defect candidates when the image defect candidates caused predetermined fluctuations on the image after the reduction processing, and removing the image defect candidates when the number of predetermined image defect candidates including the image defect candidates within a fixed range is not less than a specified number.

Preferably, a luminance component image is generated from the image data, and the image defect candidates are detected using the luminance component image.

When the image data is image data of a positive image, processing for reversing the image is preferably executed before the image defect candidates are detected.

Before the image defect candidates are detected, magnification processing is preferably executed on the image at a magnification which is previously set in accordance with an image size such that a size of each image defect in the image being processed falls within a predetermined range.

Preferably, in addition to the damage of the original and the foreign matter sticking to the original, the image defect candidates also include foreign matter sticking to a reading system of the original.

The reading system preferably includes a light-receiving surface of an image sensor in a scanner for photoelectrically reading the original.

The light-receiving surface of the image sensor is preferably a light-receiving surface of a CCD sensor.

Detection results of the image defects are preferably displayed on a manipulation screen for detecting the image defects or further correcting the image defects in a larger size than in the detection results of the image defects.

According to the present invention, there is also provided an image defect detecting method, comprising:

detecting, from image data obtained by photoelectrically shooting a subject, image defect candidates of an image to be reproduced by the image data which are due to foreign matter sticking to an image pickup system for shooting the subject; and

removing the image defect candidates in accordance with a density at which the image defect candidates are present, such that the image defect candidates present in a place where the density exceeds a predetermined state are removed and the image defect candidates which are not removed are regarded as image defects of the image to be reproduced by the image data.

The image pick-up system preferably includes a light-receiving surface of an image sensor in a digital still camera for shooting the subject.

The light-receiving surface of the image sensor is preferably a light-receiving surface of a CCD sensor.

According to the present invention, there is further provided an image defect detecting method, comprising:

detecting, from image data obtained by reading photoelectrically an original, image defect candidates of an image to be reproduced by the image data which are due to foreign matter sticking to a reading system for reading the original; and

removing the image defect candidates in accordance with a density at which the image defect candidates are present, such that the image defect candidates present in a place where the density exceeds a predetermined state are removed and the image defect candidates which are not removed are regarded as image defects of the image to be reproduced by the image data.

### BRIEF DESCRIPTION OF THE DRAWINGS

The above and other objects as well as advantages of the present invention will become clear by the following description of the preferred embodiment of the present invention with reference to the accompanying drawings, wherein:

FIG. 1 is a block diagram showing a configuration of one example of a print system for implementing an image defect detecting method of the present invention;

FIG. 2 is a conceptual block diagram showing a configuration of an exemplary scanner provided in the print system shown in FIG. 1;

FIG. 3 is a block diagram showing a configuration of an exemplary image processor provided in the print system shown in FIG. 1;

FIG. 4 is a flow chart useful in explaining one embodiment of an image defect detecting method of the present invention;

FIG. 5 is a flow chart useful in explaining one embodiment of the image defect detecting method of the present invention and is continued from FIG. 4;

FIGS. 6A, 6B, and 6C are respectively reference views useful in explaining the image defect detecting method of the present invention;

FIG. 7 is a flow chart useful in explaining the flow chart shown in FIG. 5;

FIG. 8 is a flow chart useful in explaining another embodiment of an image defect detecting method of the present invention;

FIG. 9 is a conceptual view showing a manipulation screen of image defect correction in the print system shown in FIG. 1; and

FIGS. 10A and 10B are respectively conceptual views useful in explaining a range specifying method in the manipulation screen shown in FIG. 9.

### DESCRIPTION OF THE PREFERRED EMBODIMENTS

An image defect detecting method of the present invention will hereinafter be described in detail on the basis of a preferred embodiment shown in the accompanying drawings.

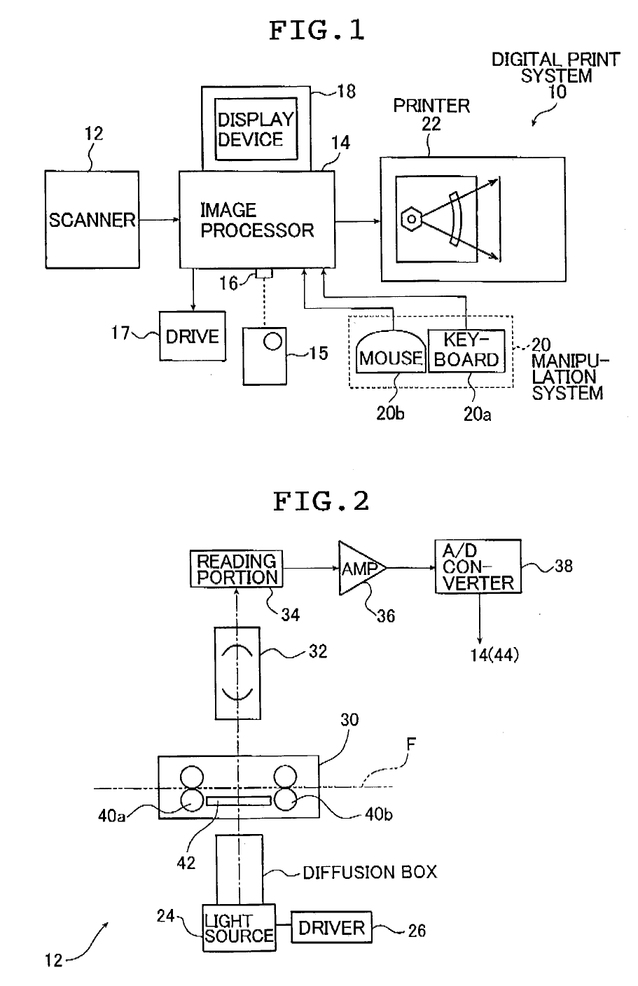

FIG. 1 is a block diagram showing a configuration of one example of a digital print system for implementing an image defect detecting method of the present invention.

A digital print system 10 (hereinafter, referred to as “a print system 10” for short) shown in FIG. 1 is adapted to output a print on which an image obtained by photoelectrically reading an image captured on a film F or photoelectrically shooting a subject by a digital still camera (DSC, hereinafter referred to as a “digital camera”) 15 is reproduced, or to output image data (image file) of an image to be reproduced on a print to a recording medium such as a CD-R. Basically, the print system 10 includes a scanner (image reader) 12, an image processor 14, and a printer 22. The image processor 14 has a connecting port 16 for connecting the digital camera 15 to the image processor 14 for reading out image data from a memory of the digital camera 15, or the image processor 14 is connected to a drive 17 for use in reading out image data of an image shot by the digital camera 15 from a recording medium onto which the image data is recorded. In addition, a display device 18 and a manipulation system 20 (including a keyboard 20a and a mouse 20b) are operatively connected to the image processor 14.

The scanner 12 is an apparatus for reading photoelectrically an image captured on the film F, and as shown in a conceptual block diagram of FIG. 2, includes a light source 24, a driver 26, a diffusion box 28, a carrier 30, an imaging lens unit 32, a reading portion 34, an amplifier 36, and A/D (analog/digital) converter 38.

In the scanner 12 in the illustrated example, the light source 24 is adapted to utilize LEDs (Light Emitting Diodes), and hence is composed of LEDs for emitting R (red) light, G (green) light, and B (blue) light which are used to read an image captured on the film F. The light source 24 is driven by the driver 26 to emit successively the R light, the G light and the B light.

The light emitted from the light source 24 is made incident on the diffusion box 28. The diffusion box 28 serves to uniform the light to be made incident on the film F in a film surface direction.

The carrier 30 conveys intermittently the film F to carry/hold successively each image captured on (each frame) of the film F to/at a predetermined read position. A plurality of kinds of carriers 30 corresponding to film sizes etc. are prepared and are adapted to be detachably attached to a main body of the scanner 12.

In the illustrated example, the carrier 30 has two pairs of carrier rollers 40a and 40b arranged so as to sandwich the read position therebetween and adapted to carry the film F in the longitudinal direction, and a mask 42 for regulating a read area of each frame.

The imaging lens unit 32 serves to image projected light from the film F on a predetermined position of the reading portion 34.

The reading portion 34 serves to photoelectrically read the film F (its projected light) using an area CCD sensor as an image sensor for photoelectrically reading an image on the film F, and reads the whole surface of one frame regulated by the mask 42 of the carrier 30 (image reading by planar exposure to light).

In the scanner 12, when the film F is to be read, the carrier 30 carries the film F so that a frame to be read reaches a read position.

Next, under the operation of the driver 26, for example, the LED of R of the light source 24 is driven to emit the R light. After the quantity of the R light has been uniformed in the surface direction of the film F through the diffusion box 28, the R light is incident on the film F in the read position (a frame in the read position) and passes therethrough to form projected light carrying an image captured on the frame. Then, the projected light is imaged on the predetermined position (the light receiving surface of the area CCD sensor) of the reading portion 34 by the imaging lens unit 32, and then the R image of this frame is photoelectrically read.

Next, the LED of G and the LED of B of the light source 24 are successively made to emit light. Then, likewise, a G image and a B image are read to complete the operation for reading this frame. Note that, the size (the number of reading pixels) of an image to be read by the scanner 12 differs depending on the size (the number of output pixels) of a print which the print system 10 is instructed to output.

After an image of one frame has been read, the carrier 30 carries the film F to carry a frame to be read next time to the read position.

An output signal from the reading portion 34 is amplified by the amplifier 36 to be converted into a digital image signal by the A/D converter 38 to be outputted to the image processor 14 (data correction portion 44).

Note that in the print system 10, image reading operations are normally carried out twice per frame. One of the image reading operations is a fine scanning operation for reading an image with high resolution for output of a print or the like, and the other is a pre-scanning operation as a low-resolution image reading operation which is carried out prior to the fine scanning operation in order to determine the read conditions for the fine scanning and the image processing conditions in the image processor 14 (image processing portion 50).

In this connection, normally, an output signal obtained from the pre-scanning operation, and an output signal from the fine scanning operation are basically identical to each other except that the output signals are different in resolution and output level.

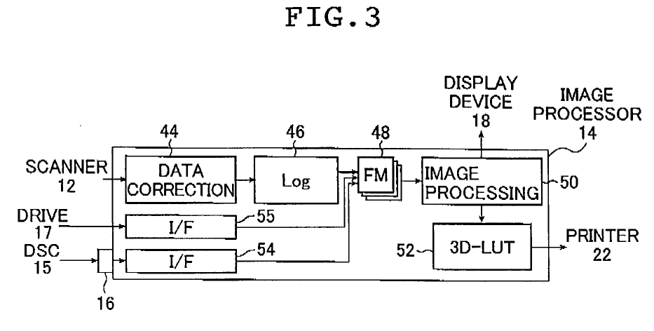

As described above, the digital image signal outputted from the scanner 12 is outputted to the image processor 14. FIG. 3 is a conceptual block diagram showing a configuration of the image processor 14.

As shown in FIG. 3, the image processor 14 includes a data correction portion 44, a Log converter 46, frame memories 48 (hereinafter, referred to as “FMs 48” for short), an image processing portion 50, and a data converting portion 52. In addition, as described above, the image processor 14 has the connecting port 16 to the digital camera 15, and the drive 17, the display device 18 and the manipulation system 20 are operatively connected to the image processor 14. Note that, in the image processor 14, a signal path may branch on the downstream of the Log converter 46 to provide a processing path through which the pre-scanning data is processed to display a simulation image for a test.

The image processor 14, for example, may be configured by combining a computer having a CPU (Central Processing Unit), a memory and the like with software or the like corresponding to this computer or further hardware.

The data correction portion 44 is a portion for subjecting the output data of R, G, and B outputted from the scanner 12 to predetermined correction such as DC offset correction, dark current correction, or shading correction.

The Log converter 46 performs logarithmic transformation of the output data processed in the data correction portion 44 into digital image (density) data (image information) using an LUT (Look-Up Table) or the like, for example.

The image data of R, G, and B which have been subjected to logarithmic transformation in the Log converter 46 are stored in the corresponding FMs 48, respectively. In addition, in the illustrated example, in the case where image data of images (image file) supplied from the digital camera 15 through the connecting port 16 or from a recording medium or the like through the drive 17 are processed, as one example, the image data are supplied from corresponding I/Fs (interfaces) 54, 55 to the FMs 48 of R, G, and B to be stored therein, respectively.

The image processing portion 50 is a portion for executing various image processing operations such as: image correction processing operations such as enlargement and reduction processing (electronic magnification processing), color and density correction processing, gradation conversion processing, sharpness processing (sharpness enhancement), and compression of an image density dynamic range (giving of the dodging effect by image data processing); and special processing operations such as soft focusing processing and a cross filter processing for the image data stored in the FMs 48.

Those image processing operations may be executed by utilizing the known method using a look-up table (LUT), a matrix arithmetic operation, filter processing and the like. Also, the image processing conditions are basically set on the basis of the image analysis using image data from pre-scanning.

In addition, when the image processing portion 50 is instructed to carry out the image defect correction (dust flaw correction), the image processing portion 50 carries out detection of image defects (hereinafter, referred to as “dust flaws”) due to flaws made on the film F, foreign matter such as dust or dirt sticking to the film F, foreign matter such as dust or dirt sticking to a reading system of the scanner 12, in particular to a light-receiving surface of an area CCD sensor of the reading portion 34, or foreign matter such as dust or dirt sticking to an image pick-up system such as the digital camera 15 for shooting a subject, in particular to a light-receiving surface of an image sensor such as a CCD by utilizing the image defect detecting method of the present invention, and moreover, carries out the correction for a dust flaw detected on the basis of the dust flaw detecting processing, and dust flaws which the image processing portion 50 is instructed to correct by the input operation made by an operator. In the following description, flaws made on the film F and foreign matter such as dust or dirt sticking to the film F will be referred to as typical cases, but the present invention is not limited thereto.

Note that, in the image processing portion 50, there is especially no limit to timing of detection and correction of dust flaws. Thus, the processing for detection and correction of dust flaws may also be executed either before other image processing operations or after completion of all other image processing operations, or may be incorporated in the middle of the image processing (e.g., the processing concerned is executed after completion of the image processing concerned with color and density, but before the image processing concerned with an image structure, and so forth). In addition, if the image structure characteristics of images of dust flaws agree with each other, then the processing may be executed using the images in different states between the detection and the correction.

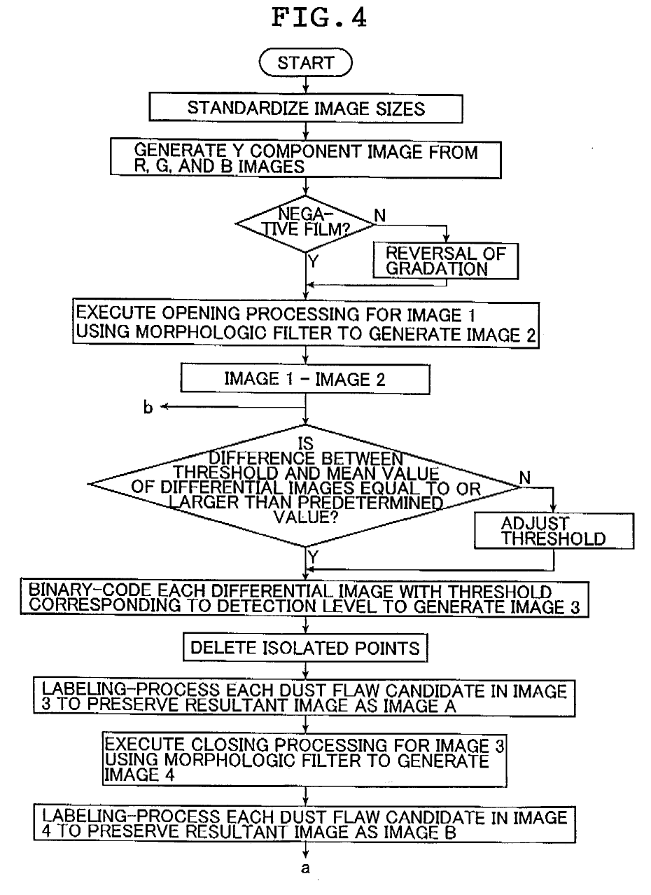

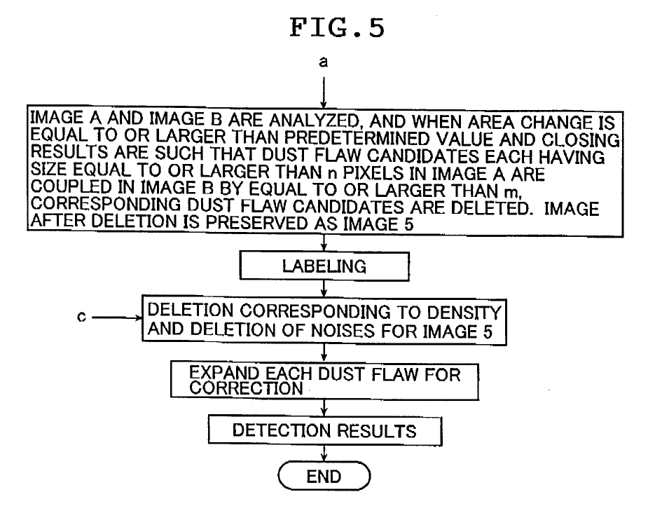

One example of a dust flaw detecting method of the present invention will hereinbelow be described with reference to flow charts shown in FIGS. 4 and 5.

In this example, as a preferred mode, first of all, the electronic magnification processing of image data is executed to standardize image sizes. This standardization of the image sizes is the processing for reducing a quantity of image data to be processed and for allowing uniform dust flaw detection parameters to be used for all sizes of images.

For example, if an output image has a size of 127 mm×178 mm (5″×7″), then the read image size is about 2,100 pixels×1,500 pixels, and if an output image has a size of 254 mm×356 mm (10″×14″), then the read image size is about 3,000 pixels×4,500 pixels, and so forth. Thus, as described above, the size (the number of read pixels) of the image read by the scanner 12 differs depending on the size (the number of output pixels) of an output image such as a print size.

On the other hand, sizes (thicknesses) of foreign matter such as dirt sticking to the film F, flaws made on the film F, or the like are relatively uniform irrespective of a size of a film or a kind of a film.

Consequently, even in the case of the same frame, when the size of a read image differs, then the size of a dust flaw (the number of pixels in a dust flaw) differs on the read image. For this reason, for highly accurate dust flaw detection, parameters for dust flaw detection needs to be set in correspondence to the image size.

In addition, there arises a problem in that if an image size is large, then it takes time to execute the processing therefor.

On the other hand, in the dust flaw detection in the illustrated example, as a preferred mode, the electronic magnification processing for an image corresponding to a size of an image to be read is executed to standardize the image sizes such that the size of an image to be processed is reduced and also the size of a dust flaw on an image to be processed falls within a predetermined range.

As a result, dust flaws can be detected with common parameters in correspondence to various image sizes, and also even in the case of an image having a large size, dust flaws can be speedily detected.

With respect to the electronic magnification ratio (enlargement/reduction ratio) for the standardization, for example, a reference image size (reference size) in the dust flaw detection has to be determined, and the electronic magnification ratio such that the size of a dust flaw on an image to be processed (an image for which a dust flaw is to be detected) becomes the same as the reference size has to be suitably determined.

Here, the electronic magnification processing for the standardization may be executed for all the cases except for the reference size. However, for image sizes smaller than the reference size, the enlargement leads to an increase in processing time, which becomes disadvantageous in productivity. For this reason, it is also preferable that such standardization of image sizes is not carried out for any of sizes equal to or smaller than the reference size. Whether or not the standardization of image sizes for any of sizes equal to or smaller than the reference size should be implemented may be suitably determined in view of equilibrium between the required processing speed and detection performance. In addition, for any of sizes equal to or smaller than the reference size, whether or not the standardization thereof should be carried out may be allowed to be suitably selected.

Next, a Y component image (luminance component image) is generated from images of R, G, and B. Note that, there is especially no limit to a method of generating a Y component image, and hence various known methods can be utilized therefor. For example, the Y component image may be generated using the following expression:

Y=0.3R+0.59G+0.11B

Moreover, in the case where an image of an original is a positive image (the film F is a reversal film), the gradation reversal is carried out to obtain a Y component image similar to a negative image. Note that, there is especially no limit to a method of gradation reversal, and any of the known methods may be adopted.

That is to say, in this example, as a preferred mode, the standardization of image sizes, the extraction of a Y component, and the gradation reversal of a positive image are carried out to allow dust flaws to be detected with common processing and parameters in all kinds of images with high accuracy irrespective of a kind of image such as a negative image or a positive image, or a color image or a monochrome image and also irrespective of an image size.

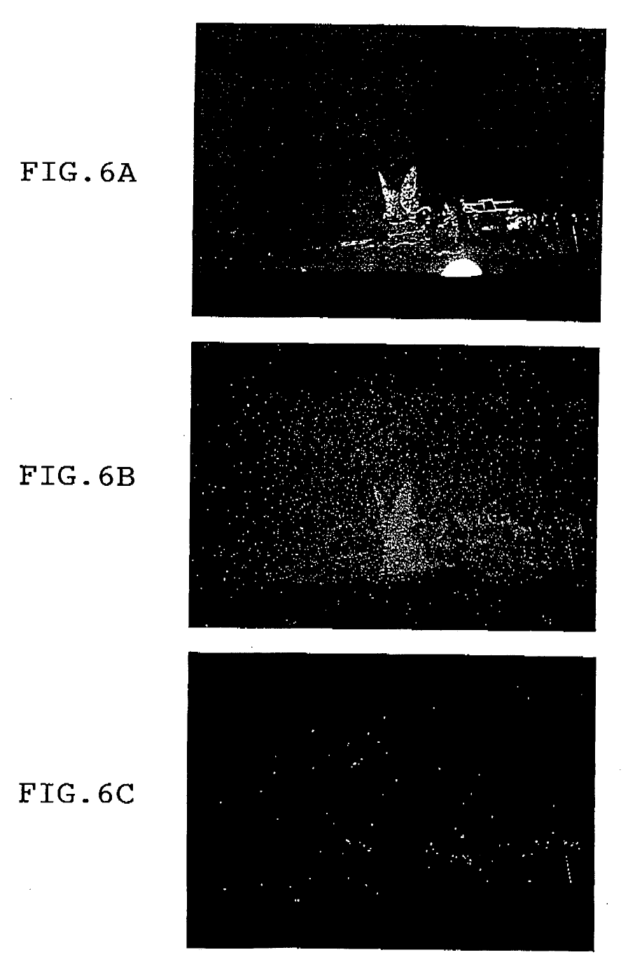

One example of an image in this state is shown in FIG. 6A. This image is obtained by photographing a parade of floats decorated with illumination.

This image is made an image 1, and then this image 1 is subjected to an opening processing using a morphologic filter to generate an image 2. Next, differential images are generated which are obtained by subtracting the image 2 from the image 1.

Next, a threshold which is set in correspondence to a detection level of dust flaws is compared with a mean value of the differential images. If a difference between the threshold and the mean value of the differential images is equal to or smaller than a predetermined value, then the threshold is adjusted.

Since when foreign matter sticks to the film F, the light for the area concerned is blocked, the image density is increased accordingly. In addition, since when flaws are made on the film F, the light for the areas concerned is diffused, the image density is similarly increased. Consequently, in the above-mentioned differential images, any of the image data other than the image data falling within a predetermined range (its luminance is equal to or lower than predetermined luminance) is not judged to be a dust flaw in terms of the image density. In the dust flaw detection in the illustrated example, first of all, any of areas each of which is judged not to be a dust flaw is deleted from such differential images using a threshold.

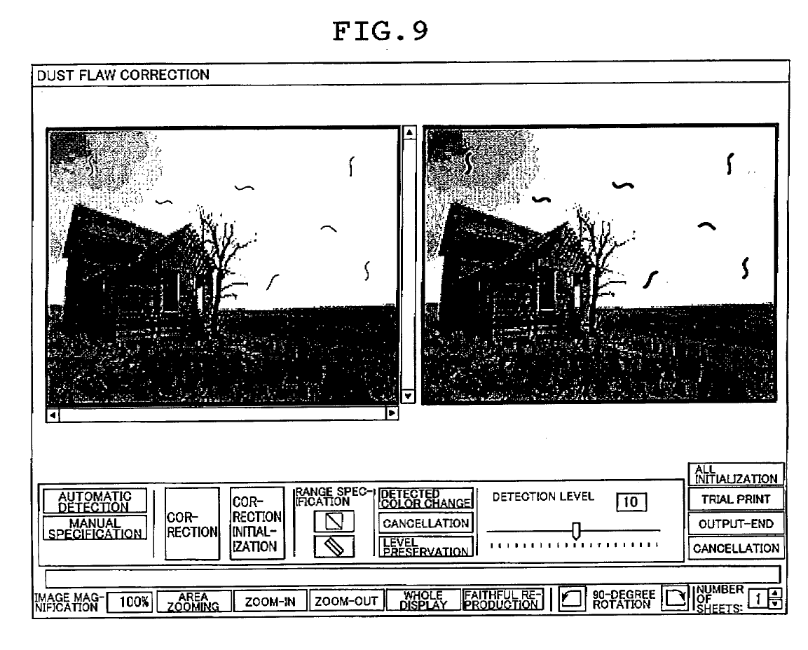

This threshold is predetermined in correspondence to “a detection level” of a manipulation screen of FIG. 9 as will be described later. In addition, “a detection level” can be adjusted by an operator manipulating the print system 10. Note that, the fact that “a detection level” is high means that a dust flaw is intensely detected (even when the possibility that a defect is a dust flaw is lower, the defect concerned is judged to be a dust flaw. That is to say, in this case, the threshold is lowered.

Here, in the case where in the differential image obtained from the above-mentioned difference of “the image 1−the image 2”, an original is an image such as a dark positive image, a great number of high luminance areas occur in the differential image. However, it is natural that not all the high luminance areas are dust flaws.

That is to say, in such an image, it is difficult to say that a threshold corresponding to a detection level is necessarily proper. As a result, there is encountered a problem in that the number of areas which are detected as dust flaw candidates is increased such that it takes a long time to execute the subsequent processing operations to thereby reduce the processing efficiency.

Here, since differential images such as dark positive images are very high in mean value, the mean value and a threshold are compared with each other, so that it is possible to judge whether or not the threshold is properly set for an image. Then, when the threshold is much lower than the mean value, the threshold is adjusted to shorten a time required for the processing to allow the processing to be efficiently executed.

There is especially no limit to a difference between a threshold and a mean value of differential images on which the adjustment of the threshold is based, and hence the difference may be suitably set in accordance with the required processing time or the like. In accordance with the examinations made by the present inventors, it is preferable in terms of a processing time, detection accuracy and the like that when a threshold is equal to or smaller than three-times as large as a mean value of differential images, the threshold is adjusted. That is to say, when the relationship of [threshold]/[mean value of differential images]>3 is not met, preferably, the threshold is adjusted.

In addition, there is especially no limit to the adjustment of a threshold, and hence such a threshold as to meet the condition may be set in accordance with a difference between an threshold and a mean value of differential images on which the adjustment of the threshold is based. For example, in the above case, there is exemplified a method of adopting [adjusted threshold]=[mean value of differential images×3]+[threshold corresponding to detection level].

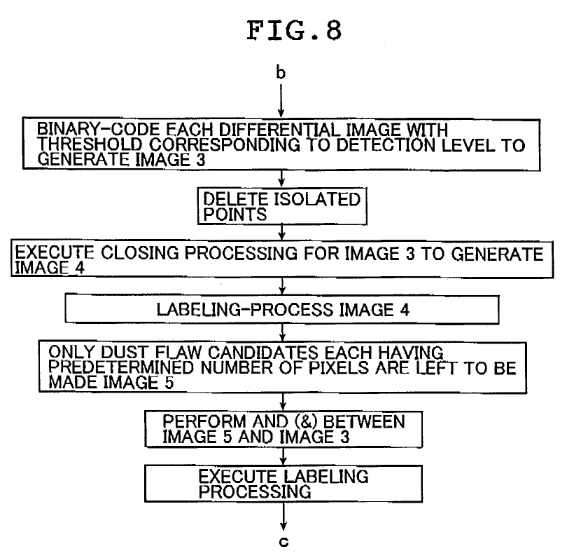

Note that, in the present invention, when a detection level of dust flaws is higher than a predetermined level previously set, i.e., when a threshold is lower than a predetermined value, for the purpose of saving a processing time, if differential images are generated on the basis of the calculation of “image 1−image 2”, on and after this processing (i.e., the process branches after completion of the judgement of the comparison between the threshold and the mean value of the differential images), the process may enter another processing (refer to an arrow b of FIGS. 4 and 8).

This regard will be described in detail later.

Next, each differential image is binary-coded with the threshold corresponding to the above-mentioned detection level to generate an image 3 from which the image defect candidates are extracted with the threshold. Moreover, any of isolated points is deleted from the image 3.

Note that, the isolated point occupies a very small area which remains as the dust flaw candidate in the image 3. As described above, the size of a dust flaw of the film F becomes clear to some degree. Consequently, any of areas (isolated points) which are smaller in size than those which can be judged to be dust flaws is deleted from the image 3 from which the dust flaw candidates are extracted to execute the subsequent processing to thereby allow dust flaws to be speedily detected.

The size of an isolated point may be suitably determined in accordance with the above-mentioned standardization or the like of images. However, it is preferable in terms of accuracy, efficiency and the like that an area equal to or smaller than that of 8 pixels, particularly, a single pixel present in the image 3 is judged to be an isolated point to be deleted.

The deletion of an isolated point results in the detection of dust flaw candidates (image defect candidates) (refer to FIG. 6B). In the processing on and after this processing, removal of any of the dust flaw candidates corresponding to the density of existence of dust flaw candidates as a characteristic point of the present invention is carried out to detect dust flaws of an image.

In accordance with the examinations made by the present inventors, a place which tends to be detected as a dust flaw by misdetection of a dust flaw using the image data of R, G, and B is a place where a pattern is formed as in a suit of clothes, light and shade of hairs of a person, windows of a building, electrical illumination as shown in FIGS. 6A to 6C, or the like. In such a place, a large number of dust flaw candidates are densely detected. That is to say, there is a high possibility that detection failed in a place where dust flaw candidates were detected with high density.

In addition, a defect which becomes a conspicuous problem in terms of the picture quality when the defect is reproduced as a visible image is a dust flaw which is present in an area having less fluctuation such as a uniform density area (set-solid area). Conversely, even if a dust flaw is present in a place where an image is being varied (a place where an image is busy), and the dust flaw is reproduced as a visible image, it is inconspicuous and hence does not become a problem in terms of picture quality at all in many cases.

Consequently, after dust flaw candidates have been detected, a highly dense part is removed on the basis of the judgement that it is not a dust flaw in accordance with the density of presence of dust flaw candidates, and also only a dust flaw candidate which is present in a place having low density of presence of dust flaw candidates is judged to be a dust flaw, so that a dust flaw leading to the large degradation in picture quality can be surely detected, and also the frequency of misdetection can be greatly reduced. As a result, for example, when the dust flaw correction is carried out in the print system 10 or the like as in the illustrated example, the processing speed and the processing efficiency can be made excellent, i.e., it is possible to realize a system which is excellent in productivity.

Note that, in the present invention, there is especially no limit to a method of detecting dust flaw candidates (image defect candidates), and hence various methods of detecting dust flaws using the R, G, and B images can be utilized. For example, dust flaw candidates may be extracted by utilizing a method of utilizing an edge detection as disclosed in JP 2000-74846 A or a method of utilizing an image of a difference between a smoothing image and an original image as disclosed in JP 2000-92319 A. In addition thereto, a method can also be utilized in which an image analysis is carried out to detect dust flaws by utilizing the continuity of pixels, the color balance with peripheral pixels, or the like.

In the detection of a dust flaw shown in the flow charts of FIGS. 4 and 5, after any of isolated points has been deleted from the image 3 in a manner as described above, first of all, labeling processing (numbering) is executed for each dust flaw candidate which is present in the image 3 from which any of isolated points has been deleted, and then the resultant image is preserved as an image A.

Moreover, the image 3 is closing-processed using a morphologic filter to generate an image 4, and then the labeling processing is executed for dust flaw candidates present in the image 4 and the resultant image is in turn preserved as an image B.

Next, when the image A and the image B are analyzed (refer to FIG. 5), and as a result, it is judged that an area of the image A is different from that of the image B by a value equal to or larger than a predetermined value, and also dust flaw candidates each having a size equal to or larger than a predetermined size (equal to or larger than n pixels) in the image A are coupled with one another in the image B by a number equal to or larger than a predetermined number (m), dust flaw candidates corresponding thereto are deleted. That is to say, the dust flaw candidate meeting the above-mentioned condition is contained in a place having high density of presence of dust flaw candidates, and hence is judged not to be a dust flaw to thereby be deleted from the image 3.

The image after the deletion of dust flaw candidates is preserved as an image 5.

The closing processing using a morphologic filter is, in a manner of speaking, such a processing as to reduce, after an image has been enlarged, the enlarged image at a magnification of restoring the size of the enlarged image to the original size thereof.

Consequently, in a place having low density of dust flaw candidates, the dust flaw candidates are not changed at all in area or the like before and after the closing processing, or, even if their areas or the like are changed, a quantity of change thereof is small. On the other hand, in a place having high density of dust flaw candidates, since adjacent dust flaw candidates are coupled with one another by the enlargement processing, and then are reduced from this state, a large change is caused in the dust flaw candidates by the closing processing.

Consequently, whether or not the dust flaw candidate concerned is present in a place having high density of presence of dust flaw candidates can be judged on the basis of an area change in the image A and the image B, and a coupling state of adjacent dust flaw candidates in the image B.

In addition, as described above, sizes of dust flaws become clear to some degree. Thus, a dust flaw candidate having a size in the image A equal to or smaller than a predetermined value is made out of an object of the judgement, so that the processing can be speedily executed. Note that, in the illustrated example, all the dust flaw candidates each having the size equal to or smaller than that of n pixels are deleted as noises in the processing as will be described later.

Here, a shape of a dust flaw is not limited to a straight line. For example, a large number of dust flaws each having a shape such as a folded line, a bent shape and a rounded shape are present. If dust flaws having such shapes are closing-processed, then for example, a part which is rounded in enlargement is crushed. As a result, even if there is no dust flaw candidate in the neighborhood thereof, a large change is caused in an area or a shape before and after the closing processing. Consequently, if the judgement is carried out only for a change in area due to the closing processing, then there is the possibility that such a dust flaw candidate may be judged not to be a dust flaw to be deleted.

On the other hand, if in addition to an area change due to the closing processing, the judgement that “m or more dust flaws are coupled with one another in the image after the closing processing (image B)” is added, not only any of dust flaw candidates present in a place having high density of dust flaw candidates is prevented from being deleted, but also such dust flaw candidates are prevented from being deleted by mistake to allow dust flaws to be detected with higher accuracy.

There is especially no limit to an area change of the image A and the image B excluded from dust flaw candidates. Thus, such an area change may be suitable determined in accordance with the above-mentioned reference size or the like of the standardization of the image sizes. In addition, there is especially no limit to the number, m, of pixels, i.e., the number of coupled dust flaws judged to be of high density as well as to the number, n, of pixels judged to be noises to be made out of an object of dust flaw candidates. Likewise, such numbers may be suitably determined in accordance with the above-mentioned reference size or the like.

In the case where the reference size of the standardization is 127 mm×178 mm (about 2,100 pixels×about 1,500 pixels), as one example, it is preferable that the image A and the image B are different in area from each other by two times or more, and also a dust flaw candidate in which four or more dust flaw candidates each corresponding to eight or more pixels are coupled with other is deleted.

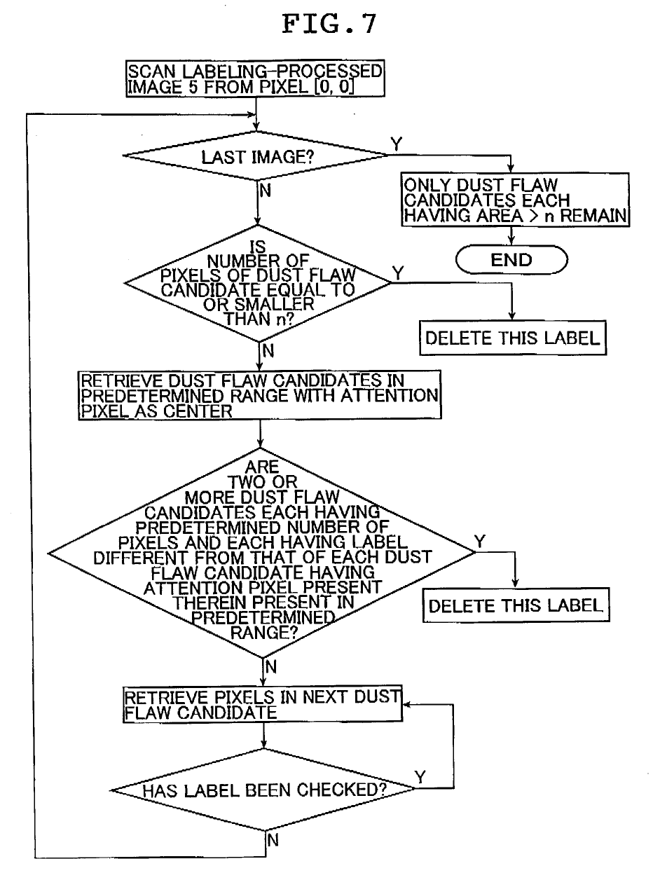

Next, the labeling processing is executed for the image 5, and then the deletion of dust flaw candidates corresponding to the number of dust flaw candidates per predetermined area (presence density), and the deletion of noises are carried out. This processing will hereinbelow be described with reference to a flow chart of FIG. 7.

As shown in FIG. 7, first of all, the labeling-processed image 5 is scanned from a pixel [0, 0] to detect pixels within a dust flaw candidate of the image 5 (detection of the labeled pixels). In addition, this scanning is carried out for up to the last pixel of the image.

After pixels within a dust flaw candidate have been detected, first of all, it is judged whether or not the number of pixels of this dust flaw candidate is equal to or smaller than n pixels. If it is judged that the number of pixels of this dust flaw candidate is equal to or smaller than n pixels, then this dust flaw candidate is deleted (deletion of this label). Note that, it is as described above that n pixels are set in accordance with the above-mentioned reference size or the like of the standardization. Then, if the reference size of the standardization is 127 mm×178 mm as described above, then as one example, the n pixels are 8 pixels. In addition, as required, the number of pixels based on the judgement in the closing processing may be made different from the number of pixels concerned.

On the other hand, when the number of pixels of the dust flaw candidate exceeds n pixels, one of the detected pixels is decided as an attention pixel, and a predetermined area which is set with the attention pixel as a center is retrieved to detect dust flaw candidates present in the predetermined area. Note that, there is especially no limit to a predetermined area in this case. Thus, similarly, the predetermined area may be suitably determined in accordance with the reference size or the like of the standardization. Hence, in the case of the size of 127 mm×178 mm, as one example, 100 pixels×100 pixels are exemplified as the predetermined area.

When it is judged on the basis of the retrieval results that in the predetermined area, dust flaw candidates of a predetermined size have respective labels each being different from a label of the dust flaw candidate having the attention pixel present therein, and also are present so as for the number thereof to exceed a predetermined number, the dust flaw candidates concerned are judged to be the dust flaw candidates present in a place having high density of dust flaw candidates. Then, the dust flaw candidate having the attention pixel present therein is deleted (deletion of this label). Note that, there is also especially no limit to the criterion of judgement for the deletion. Thus, likewise, the criterion may be suitably determined in accordance with the reference size or the like of the standardization. Hence, in the case of the size of 127 mm×178 mm as described above, as one example, it is exemplified that when two or more dust flaw candidates each having 9 pixels to 100 pixels are present, the dust flaw candidates are deleted.

After the judgement has been carried out, the scanning is carried out to reach pixels within a next dust flaw candidate. Then, it is judged whether or not a label of this dust flaw candidate has been checked (corresponding to the above-mentioned judgement). When it is judged that the label of that dust flaw candidate has been checked (Y), a next dust flaw candidate becomes a target. Such processing is repeatedly executed.

On the other hand, when it is judged that the label of that dust flaw candidate is a label of a dust flaw candidate which is not yet checked (N), the process is returned back to the first judgement processing. Then, the detection of the number of pixels of a dust flaw candidate having the pixel concerned present therein, and the retrieval for the inside of a predetermined area are carried out.

When the above-mentioned routine is repeatedly carried out to reach the final pixel of the image, the processing is completed.

As a result, only a dust flaw candidate having n or more pixels and present in a place having low density of dust flaw candidates can be detected as a dust flaw (refer to FIG. 6C). Incidentally, it is as described above that the extraction results are less in frequency of misdetection and highly accurate.

With the above-mentioned manipulation, basically, the detection of dust flaws of the present invention is completed.

Here, since normally, a dust flaw has light and shade, a dust flaw area detected through the above dust flaw detection does not show the whole area of the dust flaw concerned in some cases. For this reason, if only the detected area is judged to be a dust flaw to be corrected, then in actual, the correction may be carried out using image data of an area which is actually a dust flaw. In such cases, proper correction can not be carried out.

In view of the foregoing, in the image processing portion 50 in the illustrated example, in order to allow a dust flaw to be corrected with high accuracy, the image of a dust flaw detected through the above dust flaw detection is expanded, and the dust flaw of the expanded image is decided as the final results of detection of a dust flaw.

There is especially no limit to the expansion of an image of a dust flaw in that case. As one example, there is exemplified the expansion in which one pixel is expanded up to 8 pixels surrounding the periphery thereof, or the expansion in which one pixel is expanded up to 16 pixels surrounding the periphery thereof.

In addition, for example, the degree of the expansion of a dust flaw in this case may be so changed in accordance with a level of correction of a dust flaw as will be described later as to increase the expansion as the intensity of correction of the dust flaw is higher.

As described above, in the dust flaw detection according to the present invention, when a level of detection of a dust flaw is higher than a predetermined value which is previously set, i.e., when a threshold is lower than the predetermined value, for the purpose of saving a processing time, if differential images are generated, the processing may also enter another processing on and after that generation processing.

This processing will hereinbelow be described with reference to a flaw chart of FIG. 8.

After differential images have been generated by executing the processing for calculating “image 1−image 2” (refer to an arrow b in FIGS. 4 and 8) as shown in FIG. 4, in this processing, each differential image is binary-coded with a threshold corresponding to a detection level to generate an image 3 from which any of dust flaw candidates is extracted with the threshold, which is as shown in FIG. 8. Next, any of isolated points is deleted from the image 3.

Next, the image 3 form which any of isolated points is deleted is closing-processed with a morphologic filter to generate an image 4. Moreover, the labeling processing is executed for the image 4.

Dust flaw candidates in each of which the number of pixels falls within a predetermined range are extracted from the labeling-processed image 4 to obtain the image 5. Note that, there is especially no limit to the number of pixels of each dust flaw candidate extracted in an image 5. Thus, the number of pixels thereof may be suitably determined in accordance with the above-mentioned reference size of the standardization. If the reference size is 127 mm×178 mm as described above, then the number of pixels in the range of 8 pixels to 1,600 pixels is exemplified as one example.

After completion of the extraction, AND (&) between the image 5 and the image 3 is carried out. That is to say, only dust flaw candidates which are present in both the image 5 and the image 3 are extracted from the image 3. Next, each of the extracted dust flaw candidates is labeling-processed.

Thereafter, the processing of “removal corresponding to density and removal of noises” in the flow charts of FIGS. 4 and 5 is executed for each of the labeling-processed images (refer to an arrow c in FIGS. 5 and 8). Subsequently, the same processing is executed to complete the detection of dust flaws.

The fact that a detection level is high, i.e., a threshold is low means that a large number of dust flaw candidates are detected. Hence, in the case of the above-mentioned method, it takes a long time to execute the processing therefor. On the other hand, in accordance with the processing shown in FIG. 8, even when such a threshold is low, a processing time can be shortened and also dust flaws can be detected with excellent detection accuracy. Incidentally, a detection level (threshold) of dust flaws required in this processing may be suitably set in accordance with a processing time required, accuracy of detection of dust flaws to be attained, or the like.

Note that, in the detection of dust flaws shown in FIGS. 4, 5, and 8, in order to remove any of dust flaw candidates present in a place having high density of dust flaw candidates, as a preferred mode capable of further enhancing detection accuracy, there are carried out both the deletion of dust flaw candidates on the basis of the closing processing (enlargement and reduction processing) using a morphologic filter, and the deletion of dust flaw candidates using the number of dust flaw candidates in a predetermined range. However, the present invention is not limited thereto. Hence, the processing for carrying out only one of the deletions may also be adopted.

As described above, when the image processing portion 50 is instructed to carry out the dust flaw correction, the portion corrects any of dust flaws detected by such dust flaw detection and any of dust flaws the data of which was inputted by an operator.

Note that, there is especially no limit to a method of dust flaw correction. Thus, various known methods such as interpolation using information on peripheral pixels of a dust flaw area can be utilized. In the illustrated example, the correction for dust flaws is carried out on the basis of the interpolation using information on peripheral pixels.

In addition, while the details will be described later, in the illustrated example, a level (correction intensity) of dust flaw correction can be changed. As one example, the level of correction for dust flaws may be adjusted on the basis of extent of an area used in the interpolation. Moreover, the correction intensity may also be changed on the basis of the quantity of expansion during “dust flaw expansion for correction” in detection of dust flaws. In both the cases, a correction level becomes higher as the extent or a quantity of expansion is larger.

The description will hereinbelow be given with respect to one example of manipulation of such dust flaw correction. This manipulation may be carried out by utilizing the known method using a GUI (Graphical User Interface).

In the case where after image data have been preserved in the FMs 48, respectively, in a manner as described above, the image processing portion 50 reads out the image data thus preserved therein, and the image processing portion 50 is instructed to carry out dust flaw correction at a predetermined timing, the print system 10 enters a dust flaw correction mode, and then an image for correction of dust flaws as shown in FIG. 9 is displayed on the display device 18.

In the screen shown in FIG. 9, an image displayed on the left-hand side is an image for which dust flaw correction is to be carried out (hereinafter, this image is referred to as “an original picture”). On the other hand, the same original picture is displayed on the right-hand side as well. Then, the detection results of dust flaws, a pointer for various manipulations, a range specifying frame, and the like are superimposed on the original picture on the right-hand side. Note that, at an initial stage, the results of detection of dust flaws, and the like are not displayed, but only the original picture is displayed.

In addition, while the upper and lower side scrolling bars, and the left-hand and right-hand side scrolling bars used for the purpose of changing a display area are displayed only on the left-hand side image, the movement of these scrolling bars moves both the images in conjunction with each other.

In the illustrated example, a “90 degrees rotation” button is pressed down to thereby rotate an image by 90 degrees. A right-hand side button corresponds to the clockwise rotation, and a left-hand side button corresponds to a counterclockwise rotation.

In addition, a “zoom-in” button is pressed down to thereby enlarge the image at a predetermined magnification step by step, and the pressing-down of an “area zoom” button and the cutting-down by the mouse 20b are carried out to thereby partially enlarge the image. Moreover, in a state in which the image is enlarged, a “zoom-out” button is pressed down to thereby reduce an image step by step at every predetermined magnification, and a “whole display” button is pressed down to thereby display the whole image.

Furthermore, normally, in this manipulation screen, for the purpose of ensuring easiness of manipulation, an image for being displayed on a display device is displayed. Then, a “faithful reproduction” button is pressed down to thereby display an image close to an image to be reproduced in the form of a print.

Upon pressing-down of an “automatic detection” button by an operator, the image processing portion 50 carries out the dust flaw detection shown in FIGS. 4 and 5 (or also FIG. 8). Then, as shown in FIG. 9, images of dust flaws are enhanced by utilizing a method of coloring on the original image, and so forth to thereby display the results of detection of dust flaws superimposed on the right-hand side original picture. In the illustrated example, seven dust flaws are detected.

Here, in order that even fine dust flaws may be favorably or definitely identified, dust flaws in the manipulation screen are preferably displayed in the form of a slightly larger image than that of the final detection results shown in FIG. 5.

Note that as described above, prior to the issue of an instruction for the automatic detection, a slider bar of a “detection level” is adjusted to allow a detection level (threshold) for dust flaws to be judged (when there is no issue of an instruction, a detection level is set to a medium (10 in this example)). In addition, upon pressing-down of a “level preservation” button, the set detection level is preserved, and then the next dust detection will be started with this detection level.

The detection results of dust flaws are firstly colored M (Magenta), for example, to be displayed in the form of an enhanced image. Then, by the pressing-down of a “detection color change” button, the displayed color of the detection results of dust flaws is successively changed to other colors, e.g., C (cyan) to M through Y (yellow).

As a result, dust flaws can be surely identified irrespective of the background or the like.

In the illustrated example, region specification is carried out for such results of detection of dust flaws to allow various manipulations to be carried out.

Note that, in the illustrated example, the specification of a rectangular range with the mouse 20b, and the manual range specification are set. In addition, as for the specification of a rectangular range with the mouse 20b, the following two kinds of range specifications are set.

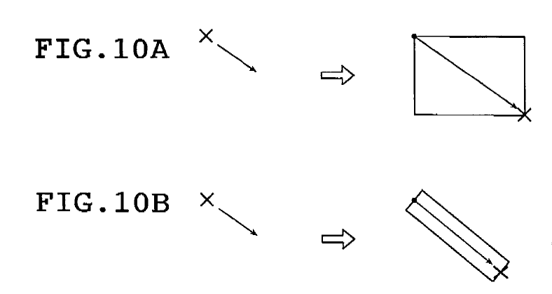

As for a “region specification” button of the GUI on the display screen, an upper-side button is pressed down to thereby carry out dragging in an arbitrary direction from an arbitrary position instructed (clicked) on the screen using the mouse 20b as shown in FIG. 10A, so that it is possible to specify an arbitrary rectangular range having a line obtained by the dragging as a diagonal line.

On the other hand, a lower side button of the GUI on the display screen is likewise pressed down to thereby carry out the dragging in an arbitrary direction from an arbitrary position specified on the screen, so that a rectangle with a predetermined width and having a side extending in this dragging direction is drawn as shown in FIG. 10B. The operation for drawing a rectangle is completed after the end of the dragging, and next, a width (perpendicular to the dragging direction) is adjusted by clicking a right-hand side button of the mouse to thereby specify a range in the form of an arbitrary rectangle in an oblique direction. This range specifying method makes it possible to suitably specify any of dust flaws as well obliquely made on a film without containing any of unnecessary areas.

On the other hand, a “manual specification” button is pressed down, so that it is also possible to carry out the manual specification using a pen tool, an eraser tool, a line segment tool or the like. Note that, the manipulation using such tools may be carried out by utilizing the known method. In addition, in the case of the manual specification, the range may not also be specified, but a displayed dust flaw itself may be specified.

Here, when the “manual specification” button is pressed down, the display of an image on the manipulation screen becomes the enlargement display of only the image having dust flaws displayed thereon (on the right-hand side of the two displayed images).

Naturally, such range specification for a plurality of places can be carried out for one processing operation, and also different kinds of range specifications can be carried out for one processing operation.

As the manipulation for the automatic detection results, when dust flaws which could not be properly detected are intended to be detected (i.e., when dust flaws which were not detected though they are judged to be dust flaws from an image are intended to be detected), for example, after such a range specification and the adjustment of a detection level have been carried out, the “automatic detection” button is pressed down again. By this manipulation, the image processing portion 50 detects dust flaws only in the region concerned at the readjusted detection level.

In addition, when dust flaws which were detected by mistake (parts which were detected as dust flaws though they do not contain any of dust flaws) are intended to be erased, after the same range specification has been carried out, a “cancellation” button is pressed down. As a result, the image processing portion 50 deletes any of dust flaws which were detected in a specified range. Note that, the deletion of dust flaws detected by mistake may also be carried out by performing the automatic detection in a state in which a detection level is set to “0” after the range specification of a misdetection area has been carried out.

Alternatively, such a procedure may also be adopted that only area in which dust flaws were properly detected is specified to issue an instruction, so that dust flaws of the area which were not specified are deleted as dust flaws detected by mistake.

When a “correction” button is pressed down by an operator after the dust flaw detection as described above has been carried out, the image processing portion 50 corrects dust flaws on the basis of the interpolation using the image data in peripheral areas of the dust flaws, which is as described above. In addition, the image in which dust flaws has been corrected (i.e., the results of correction of dust flaws) is displayed on the right-hand side of the screen.

In addition, in response to the pressing-down of the “correction” button, the “correction” button and the slider bar of a “detection level” make transition to a “decision” button and the slider bar of a “correction level”, respectively.

At the time when the correction level has been adjusted with the slider bars after completion of the correction, the “decision” button makes transition to the “correction” button again. Upon pressing-down of the “correction” button under this condition, the image processing portion 50 carries out the correction with the adjusted correction level again. Incidentally, the recorrection is basically carried out for the original picture.

In addition, upon pressing-down of a “correction initialization” button, the image in which the dust flaw correction is carried out is returned back to the state right before carrying out the dust flaw correction.

Moreover, such recorrection and initialization of correction may also be carried out only for the specified range in accordance with the above-mentioned range specification.

If in the print system 10 in the illustrated example, a “trial print” button on the manipulation screen is pressed down during manipulation for the dust flaw correction, then a print of an image in which the dust flaw correction is carried out at this time point is outputted accordingly (output of a trial print). As a result, a state of correction of dust flaws can be confirmed from an actual print.

Note that, the operation for outputting a print will be described in detail later.

When the correction of dust flaws is carried out in a manner as described above, and then the dust flaw correction is judged to be carried out properly for an image, an operator presses down the “decision” button. In response to this manipulation, the image correction portion 50 decides the dust flaw correction for this image. Moreover, upon pressing-down of an “output-end” button, a next processing operation is started for that image, and also the dust flaw detection mode is completed.

Here, in the present invention, it is preferable that the “decided” image for which the dust flaw correction has been completed is not erased but preserved. As a result, for example, even in the case where a part in which dust flaws are left uncorrected, correction mistake or the like is found out after a (finished) print has been outputted, the additional correction can be carried out from the preserved image, so that the enhancement of processing efficiency, the shortening of a processing time, and the like can be attained.

If an “all initialization” button is pressed down during the above-mentioned processing operations for an image, then all the processing operations for the image are cancelled to return the process back to an initial state before carrying out the dust flaw detection.

In addition, likewise, if a “cancellation” button is pressed down, then all the manipulations are cancelled such that the operation mode of the print system 10 is returned back to a mode in which no dust flaw correction is carried out.

Moreover, in the print system 10 in the illustrated example, the number of copies of the image after the dust flaw correction can be set in this manipulation screen using an up/down of “the number” button.

The image data processed in the image processing portion 50 is then processed in the data converting portion 52. The data converting portion 52 is a portion for converting image data into image data corresponding to an image output by the printer 22 using a three-dimensional LUT (3D-LUT), for example.

The printer 22 is a known color printer. For example, there is exemplified a printer in which after a photosensitive material such as photographic printing paper is two-dimensionally scanned and exposed with a light (laser) beam modulated in accordance with the supplied image data of R, G, and B to record a latent image thereon, and the exposed photosensitive material is subjected to the wet developing processing of developing/fixing/washing to visualize the latent image, the resultant photosensitive material is dried to be outputted in the form of a print.

Note that, in the print system 10 of the present invention, in addition to the output of a print, the image data processed in the correction portion 54 may be converted into an image file of JPEG, for example, to be outputted to a recording medium such as a CD-R.

Hereinabove, the image defect detecting method of the present invention has been described in detail. However, it is to be understood that the present invention is not intended to be limited to the above-mentioned embodiment, and hence the various improvements and changes may be made without departing from the scope and sprit of the invention.

In the above-mentioned example, the image defect detection is carried out all over the whole area of an inputted image. However, for example, the image defect detection may be carried out only for an area corresponding to an output image or only for a specified area. Moreover, any one of the whole area, an output image area, and a specified area may be allowed to be selected for the image defect detection.

In addition, in the illustrated example, the detection of image defects is carried out using fine scan data obtained by the scanner 12. However, the present invention is not intended to be limited thereto. Hence, if possible in terms of resolution or the like, the productivity is regarded as important and thus the detection of image defects may be carried out using pre-scan data.

Moreover, while in the illustrated example, image defects due to dust flaws of the film F (transmission type original) are detected, in the present invention, image defects may be detected from image data obtained by reading photoelectrically a reflection type original. As described above, it is to be understood that an image defect due to a dust flaw sticking to a reading system for photoelectrically reading the film F (transmission type original) or a reflection type original, in particular to a light-receiving surface of an image sensor such as a CCD sensor and an image defect due to a dust flaw sticking to an image pick-up system such as a digital camera (DSC) for shooting a subject, in particular to a light-receiving surface of an image sensor such as a CCD sensor may be detected.

As set forth in detail, according to the present invention, image defect candidates detected by mistake are deleted before determining final image defects in accordance with the density of presence of the detected image candidates. Hence, it is possible to surely detect image defects existing in a set-solid area and the like which cause a serious problem when reproducing an image, and also it is possible to efficiently carry out the highly accurate image defect detection with less frequency of misdetection.

What is claimed is:

1. An image defect detecting method, comprising:
detecting, from image data obtained by reading photoelectrically an original or by shooting photoelectrically a subject, image defect candidates of an image to be reproduced by the image data which are due to damage of the original and foreign matter sticking to the original, or foreign matter sticking to an image pick-up system for shooting said subject; and
removing said image defect candidates in accordance with a density at which said image defect candidates are present, such that said image defect candidates present in a place where the density exceeds a predetermined state are removed and the image defect candidates which are not removed are regarded as image defects of the image to be reproduced by said image data.

2. The image defect detecting method according to claim 1, wherein said removing of the image defect candidates present in said place where said density exceeds a predetermined state comprises: executing enlargement processing on said image defect candidates; then executing reduction processing on the thus enlarged image defect candidates; and at least one of removing said image defect candidates when said image defect candidates caused predetermined fluctuations on the image after the reduction processing, and removing said image defect candidates when the number of predetermined image defect candidates including said image defect candidates within a fixed range is not less than a specified number.

3. The image defect detecting method according to claim 1, wherein a luminance component image is generated from the image data, and said image defect candidates are detected using said luminance component image.

4. The image defect detecting method according to claim 1, wherein when said image data is image data of a positive image, processing for reversing the image is executed before said image defect candidates are detected.

5. The image defect detecting method according to claim 1, wherein before the image defect candidates are detected, magnification processing is executed on the image at a magnification which is previously set in accordance with an image size such that a size of each image defect in the image being processed falls within a predetermined range.

6. The image defect detecting method according to claim 1, wherein, in addition to said damage of the original and said foreign matter sticking to the original, said image defect candidates also include foreign matter sticking to a reading system of said original.

7. The image defect detecting method according to claim 6, wherein said reading system includes a light-receiving surface of an image sensor in a scanner for photoelectrically reading said original.

8. The image defect detecting method according to claim 7, wherein the light-receiving surface of said image sensor is a light-receiving surface of a CCD sensor.

9. The image defect detecting method according to claim 1, wherein detection results of said image defects are displayed on a manipulation screen for detecting said image defects or further correcting said image defects in a larger size than in the detection results of said image defects.

10. The image defect detecting method according to claim 1, wherein said image pick-up system includes a light-receiving surface of an image sensor in a digital still camera for shooting said subject.

11. The image defect detecting method according to claim 10, wherein the light-receiving surface of said image sensor is a light-receiving surface of a CCD sensor.

12. An image defect detecting method, comprising:
detecting, from image data obtained by reading photoelectrically an original, image defect candidates of an image to be reproduced by the image data which are due to foreign matter sticking to a reading system for reading said original; and
removing said image defect candidates in accordance with a density at which said image defect candidates are present, such that said image defect candidates present in a place where the density exceeds a predetermined state are removed and the image defect candidates which are not removed are regarded as image defects of the image to be reproduced by said image data.
